(19) United States
(12) Patent Application Publication
(10) Pub. No.: US 2014/0369313 A1
(43) Pub. Date: Dec. 18, 2014

(54) METHOD AND APPARATUS FOR ENABLING RE-ESTABLISHMENT PROCEDURE IN A HETEROGENEOUS NETWORK

(71) Applicants: Haitao Li, Beijing (CN); Kodo Shu, Beijing (CN)

(72) Inventors: Haitao Li, Beijing (CN); Kodo Shu, Beijing (CN)

(73) Assignee: Nokia Corporation, Espoo (FI)

(21) Appl. No.: 14/240,743

(22) PCT Filed: Sep. 9, 2011
(86) PCT No.: PCT/CN2011/079497

§ 371 Date: Feb. 25, 2014

(51) Int. Cl. H04W 36/00

(52) U.S. Cl. CPC H04W 36/0033; H04W 76/028
USPC 370/331

(57) ABSTRACT

The present invention relates to method and apparatus for enabling re-establishment procedure in a heterogeneous network. According to an embodiment of the present invention, a method for a master node working with inter-site carrier aggregation in a heterogeneous network is provided. The method comprises: performing detection for whether there is a trigger for transferring UE context which is indispensable for a successful re-establishment procedure for a user equipment to at least one slave node; transferring, once said trigger is detected, said UE context to said at least one slave node. According to an embodiment of the present invention, there is also provided an apparatus of a master node, and corresponding computer program product.

### TECHNICAL FIELD

The present invention generally relates to a communication system, particularly to a method and apparatus for enabling re-establishment procedure of in a heterogeneous network.

### DESCRIPTION OF THE RELATED ART

Heterogeneous networks (HetNet) Mobility topic which has been launched as a Study Item in 3GPP LTE Release-11 to optimize UE's mobility performance in HetNet scenarios. In traditional networks, macro cells/eNBs are widely deployed by operators, while in heterogeneous networks, apart from traditional macro cells/eNBs, some other types of cells with smaller size are playing an important role in their own specific appealing fields for wireless broadband access. Among them, pico eNBs are normally deployed by operator for offloading traffic in hot spot coverage. Closed Subscriber Group (CSG) HeNBs, Hybrid HeNBs, or Femto eNBs are deployed by home users or enterprises for subscribed charging and services. In between, CSG and open cells, hybrid cells are deployed in some public places (e.g. café or shopping mall) by operators for better tradeoff of QoS provisioning between subscribers and open users.

Prior to the HetNet presence, UE's mobility performance is mostly optimized based on macro networks which are deployed by operator in a coordinated way. With the introduction of small-size HetNet cells, the coverage model and coordination mode between different cells are more or less changed (especially for CSG HeNBs), which raises more challenges for the network to efficiently manage UE's mobility state, w.r.t. some RRC procedures like measurement, connection (re-)establishment, handover, etc.

An increasing number of HetNet elements (i.e. small cells) are placed in an area where macro cells/eNBs have been carefully deployed in a coordinated fashion. From network's perspective, it has more flexibility for UE's mobility management due to more neighbor/candidate cells for handover purpose. This also implies that fast moving UE might experience more frequent handovers in HetNet scenarios than macro-only scenarios, either for its subscription preference or for network offloading reason. Due to the fact that HetNet elements normally have a smaller size compared to macro cells, handover failure rate might be even higher as sometimes handover cannot be completed when UE has moved out of this small cell after receiving handover command. Besides frequent handover failure, some HeNBs deployed on the same frequency layer of macro eNBs will cause too much co-channel interference to macro UEs. In this case, UE will experience more frequent radio link failure. Currently, the remedy to handover failure and radio link failure is by attempting connection re-establishment of UE. However, by running re-establishment procedure, it is likely for UE to end up with selecting a non-prepared cell which has no UE context and then returning to IDLE state. If this re-establishment failure occurs frequently, it will cause very bad user experience.

In the prior art, some efforts are made to improve re-establishment performance. International Patent Application PCT/EP2010/050037, published as WO2011082822A1 relates to a solution of re-establishment of component carriers for UE working with carrier aggregation (CA), which is herewith incorporated by reference. The main idea of the solution is to prioritize Secondary Cell (SCell) for UE sending re-establishment request, since SCell has the UE context (is prepared) and thus has a better potential to reestablish the connection than other non-configured cells. This solution is valid for co-site CA, i.e., the case where all aggregated cells are located in a single eNB.

### SUMMARY OF THE INVENTION

One or more method and apparatus embodiments according to the present invention aim to provide an improved solution for enabling re-establishments procedure, especially for UEs working with inter-site CA.

According to an aspect of the present invention, an embodiment of the present invention provides a method for a master node working with inter-site carrier aggregation in a heterogeneous network. The method comprises: performing detection for whether there is a trigger for transferring UE context which is indispensable for a successful re-establishment procedure for a user equipment to at least one slave node; transferring, once the trigger is detected, the UE context to the at least one slave node.

According to another aspect of the present invention, an embodiment of the present invention provides an apparatus of a master node working with inter-site carrier aggregation with said master node in a heterogeneous network. The apparatus comprises: detecting means for detecting a trigger for transferring UE context which is indispensable for a successful re-establishment procedure for a user equipment to at least one slave node; transferring means for transferring, once said trigger is detected, said UE context to said at least one slave node.

According to further aspect of the present invention, an embodiment of the present invention provides a computer program product embodied in a computer readable medium the execution of which by a data processor of a master node working with inter-site carrier aggregation in a heterogeneous network comprises operations of: performing detection for whether there is a trigger for transferring UE context which is indispensable for a successful re-establishment procedure for a user equipment to at least one slave node; transferring, once said trigger is detected, said UE context to said at least one slave node.

### BRIEF DESCRIPTION OF THE DRAWINGS

Inventive features regarded as the characteristics of the present invention are set forth in the appended claims. However, the present invention, its implementation mode, other objectives, features and advantages will be better understood through reading the following detailed description on the exemplary embodiments with reference to the accompanying drawings, where in the drawings:

FIG. 1 shows an example of a communication system in which the embodiments of the invention may be implemented;

FIG. 2 shows an example of UE context transfer according to an embodiment of the present invention;

FIG. 3 schematically shows another example of UE context transfer according to an embodiment of the present invention;

FIG. 4 schematically shows a flowchart of the method for enabling re-establishment in a heterogeneous network according to an embodiment of the present invention;

FIG. 5 schematically shows an example of a macro eNB apparatus according to an embodiment of the present invention.

### DETAILED DESCRIPTION OF THE PREFERRED EMBODIMENT

Hereinafter, embodiments of the present invention will be described with reference to the accompanying drawings. In the following description, many specific details are illustrated so as to understand the present invention more comprehensively. However, it is apparent to the skilled in the art that implementation of the present invention may not have these details. Additionally, it should be understood that the present invention is not limited to the particular embodiments as introduced here. On the contrary, any arbitrary combination of the following features and elements may be considered to implement and practice the present invention, regardless of whether they involve different embodiments. Thus, the following aspects, features, embodiments and advantages are only for illustrative purposes, and should not be understood as elements or limitations of the appended claims, unless otherwise explicitly specified in the claims.

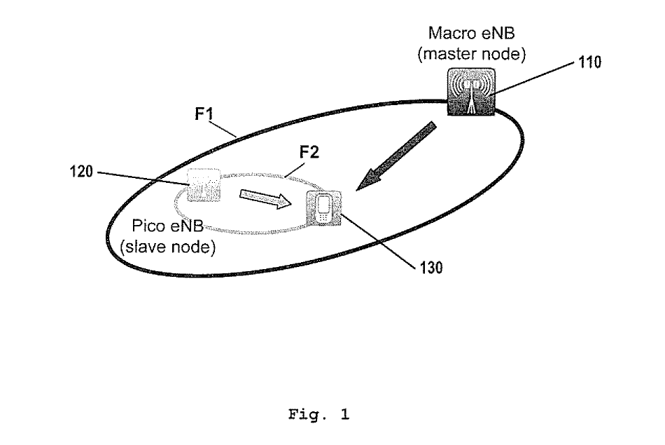

FIG. 1 shows an example of a heterogeneous network in the inter-site CA scenario, in which the embodiments of the invention may be implemented.

As shown in FIG. 1, reference 110 denotes a macro eNB in charge of a cell F1; reference 120 denotes a pico eNB in charge of a cell F2; and reference 130 denotes a UE communicating via the heterogeneous network comprising cells F1 and F2. The coverage of the cells F1 and F2 is overlapped. When UE 130 is within the overlapping coverage, traffic steering or offloading can be easily achieved by UE 130 through inter-site CA.

The scenario of inter-site CA as shown in FIG. 1 involves the macro cell (cell F1) of macro eNB 110 and the pico cell (cell F2) of pico eNB 120. In the scenario of inter-site CA involving different eNBs, the eNB in charge of the Primary Cell (PCell) such as macro eNB 110 can be referred to as “master node”, while inter-site eNB such as pico eNB 120 can be referred to as “slave node”. Those skilled in the art may appreciate that pico eNB 120 is only an example of a slave node. Besides a pico eNB, any small eNB such as a CSG HeNB, a Hybrid HeNB a Femto eNB may also act as a slave node which is involved in inter-site CA.

3GPP LTE Radio Protocol TS36.331 specifies the re-establishment procedure. A trigger for a re-establishment procedure can be detected by UE and thus causes a re-establishment procedure. When UE sends re-establishment request, it includes re-establishment cause and some security information (i.e. ShortMAC-I). After receiving it, eNB requested will check whether it has valid security context and other UE context (like AS-Config). Only if the answer is yes, can subsequent re-establishment be performed by the eNB. Thus, eNB which is requested to re-establish a connection with UE is required to hold necessary UE context for completing a successful re-establishment procedure.

According to WO2011082822A1 as described above, it will be advantageous that UE can prioritise the SCell for the re-establishment procedure when a trigger of re-establishment procedure is detected by UE. That is because, in the co-site CA scenario, the SCell is located at the same eNB with PCell and has already maintained the UE context. Thus, the SCell in the co-site scenario has a better potential to recover connection than other non-configured cells.

However, there would be a problem in the inter-site CA scenario. As a matter of fact, when working with inter-site CA, for normal inter-site SCell operation, the slave node in charge of this SCell such as pico eNB 130 in charge of pico cell F2 does not have the entire UE context which is indispensable for a successful re-establishment. In this case, even if UE 130 selects the SCell and initiates re-establishment request, such re-establishment will still not succeed due to the lack of necessary UE context in the side of eNB requested. Herein, the UE context comprises but not limits to As-context, AS-Config and security context like ShortMAC-I, KeNB*, etc. Those skilled in the art may appreciate that the term “UE context” may refer to any kind of context information of UE which is indispensable for a successful re-establishment regardless of whether specific context is described herein.

According to an embodiment of the present invention, a solution is proposed for enabling re-establishment procedure in the heterogeneous network, especially for the inter-site CA scenario. A new signaling procedure is defined for transferring UE context from master node to slave nodes under inter-site CA scenario. This can be done by transferring UE context from the master node to slave nodes, via a specific interface at network side.

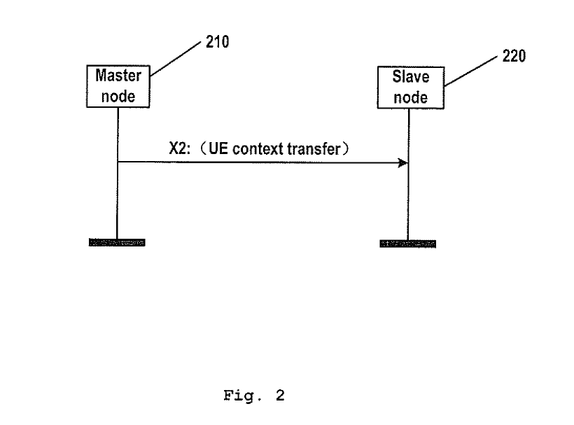

FIG. 2 shows an example of UE context transfer according to an embodiment of the present invention, wherein the master node transfers UE context to slave nodes via X2 interface specified in 3GPP Long Term Evolution (LTE) System Architecture.

As shown in FIG. 2, reference numeral 210 denotes a master node such as macro eNB; reference numeral 220 denote a slave node, which can be one from a group comprising pico eNBs, CSG HeNBs, Hybrid HeNBs, and Femto eNBs.

In 3GPP LTE System Architecture, X2 interface is an interface by which eNBs are interconnected with each other. Through X2 interface, master node 210 in charge of the PCell can transfer the UE context which is indispensable for a successful re-establishment to slave node 210 in charge of a SCell. The UE context may include but not be limited to: AS-Config, AS-context, and security context like ShortMAC-I, KeNB*. Therefrom, slave node 210 is prepared for potential re-establishment of UE (not shown). When UE selects the SCell of slave node 210 to initiate a re-establishment request, the re-establishment will not fail due to the lack of necessary UE context in the side of eNB requested.

Such UE context transferring from master node 210 to slave node 220 can be trigged by specified trigger events. Some advantageous examples of the trigger events are listed as follows.

Trigger a): UE context transferring is triggered whenever UE enters into inter-site CA mode. That is, whenever slave node 220 is newly configured to a UE, master node 210 transfers the UE context to slave node 220. This kind of trigger can be applied alone or applied in combination with other triggers. When applied alone, the trigger is favorable to the situation where UE context rarely changes in the master node side. As for the situation where UE context changes relatively frequently in the eNB side, the trigger can be applied in combination with other triggers to improve the accuracy of UE context maintained in slave node 220.

Trigger b): UE context transferring is trigged whenever UE context is changed in master node 210. Since re-establishment is triggered by UE autonomously, i.e., normally master node 210 does not know the exact time when UE's handover failure or RLF happens, master node 210 can transfer the UE context to slave node 220 once the UE context has changed so that slave node 220 always has the most up-to-date UE context. This kind of trigger can be applied in combination with Trigger a) so as to update the UE context in slave node 220 when the UE context changes in master node 210.

Trigger c): UE context transferring is triggered by the handover failure detection at the master node side, e.g. when master node 210 does not receive handover complete message. This trigger is suitable for the situation where the re-establishment is triggered by handover failure. When UE initiates re-establishment caused by handover failure to slave node 220, master node 210 might have transferred the UE context through backhaul link to slave node 220 to make it prepared for the re-establishment. Note that, this does not work for the re-establishment triggered by radio link failure since network has totally no idea when it happens. This kind of trigger can be applied in combination with Trigger a) or Triggers a) and b).

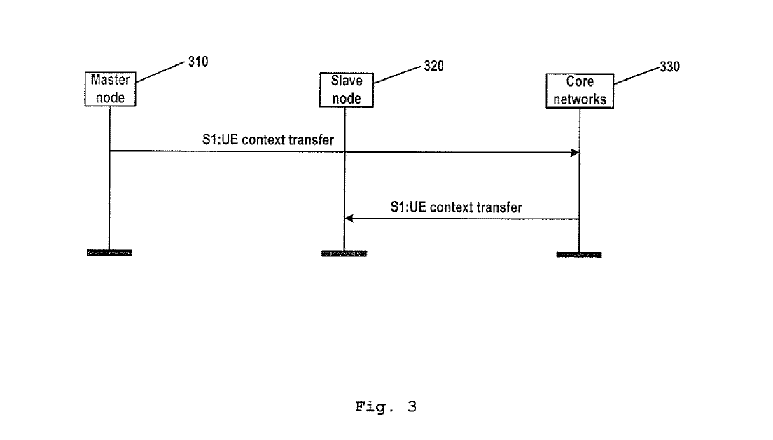

FIG. 3 schematically shows another example of UE context transfer according to an embodiment of the present invention, wherein the master node transfers UE context to slave nodes via S1 interface specified in 3GPP Long Term Evolution (LTE) System Architecture.

As shown in FIG. 3, reference numeral 310 denotes a master node such as macro eNB; reference numeral 320 denote a slave node and can be one from a group comprising pico eNBs, CSG HeNBs, Hybrid HeNBs, and Femto eNBs.

In 3GPP LTE System Architecture, S1 interface is an interface by which eNBs are interconnected with the core networks. Through S1 interface, master node 310 in charge of the PCell transfers the UE context which is indispensable for a successful re-establishment to the core networks 330. From core networks 330, the UE context is forwarded to slave node 310 in charge of a SCell via S1 interface. The UE context may include but not be limited to: AS-Config, AS-context, and security context like ShortMAC-I, KeNB*, etc. Therefrom, slave node 310 is prepared for potential re-establishment of UE (not shown). When UE selects the SCell of slave node 310 to initiate a re-establishment request, the re-establishment will not fail due to the lack of necessary UE context in the side of eNB requested.

Similarly, such UE context transferring from master node 310 to slave node 320 through core networks 330 via S1 interface can be trigged by specified trigger events. Some advantageous examples of trigger events are the same as those for X2 interface, for which detailed description is omitted here for the purpose of concision.

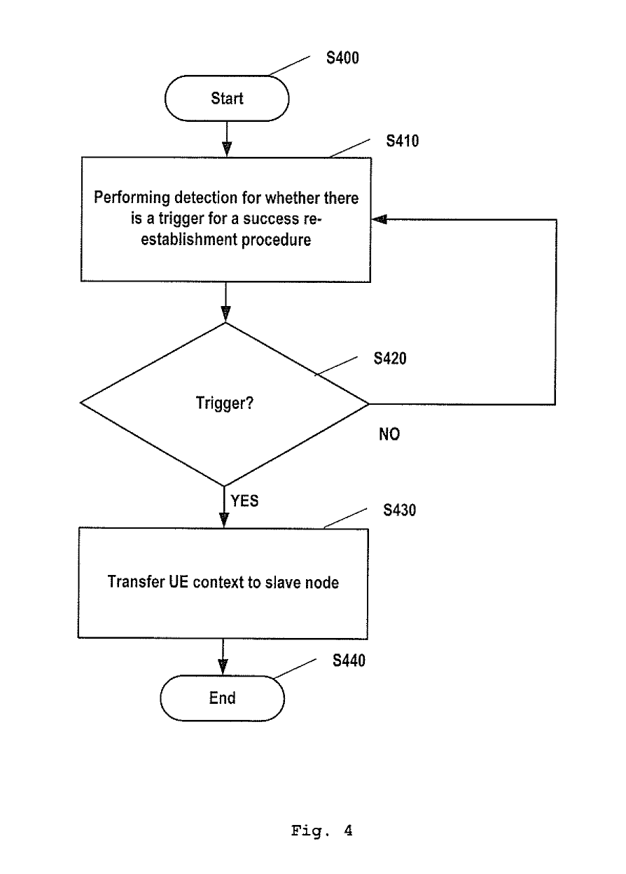

FIG. 4 schematically shows a flowchart of the method for enabling re-establishment in a heterogeneous network according to an embodiment of the present invention

As shown in FIG. 4, at step S400, the processing flow of the method for enabling re-establishment in a heterogeneous network according to an embodiment of the present invention starts.

At step S410, detection is preformed for whether there is a trigger for transferring UE context to slave node. The UE context is indispensable for a successful re-establishment and may include but not be limited to: AS-Config, AS-context, and security context like ShortMAC-I, KeNB*, etc.

A master node working with inter-site CA in a heterogeneous network can detect whether a plurality of specified trigger events are happened. Some advantageous examples of the trigger events comprise:

Trigger a): UE context transferring is triggered whenever UE enters into inter-site CA mode. That is, whenever a slave node is newly configured to a UE, the master node transfers the UE context to the slave node. This kind of trigger can be applied alone or applied in combination with other trigger(s). When applied alone, the trigger is favorable to the situation where UE context rarely changes in the master node side.

Trigger b): UE context transferring is trigged whenever UE context is changed in the master node. The master node can transfer the UE context to the slave node(s) once the UE context has changed so that the slave node(s) always has the most up-to-date UE context. This kind of trigger can be applied in combination with Trigger a) so as to update the UE context in the slave node(s) when the UE context changes in the master node.

Trigger c): UE context transferring is triggered by the handover failure detection at the master node side, e.g. when the master node does not receive handover complete message. This trigger is suitable for the situation where the re-establishment is triggered by handover failure. When UE initiates re-establishment caused by handover failure to the slave node, the master node might have transferred the UE context through backhaul link to the slave node to make it prepared for the re-establishment. This kind of trigger can be applied in combination with Trigger a) or Triggers a) and b).

At step S420, if a trigger is detected, then the processing flow proceeds with step S430; if not, then the processing flow proceeds with step S410.

At step S430, up-to-date UE context is transferred to a slave node(s).

In an embodiment of the present invention, the master node can transfer UE context via X2 interface, by which eNBs are interconnected with each other, to the slave node(s). In this way, a slight increase of backhaul signaling overhead is needed, which however is normally tolerable.

In another embodiment of the present invention, the master node can transfer UE context via S1 interface by which eNBs are interconnected with the core networks, to the core networks. Through the core networks, the UE context is then transferred to the slave node(s). Compared with the X2 solution, the solution based on S1 interface causes further a bit of core network overhead, which however is also tolerable.

At step S440, the processing flow end.

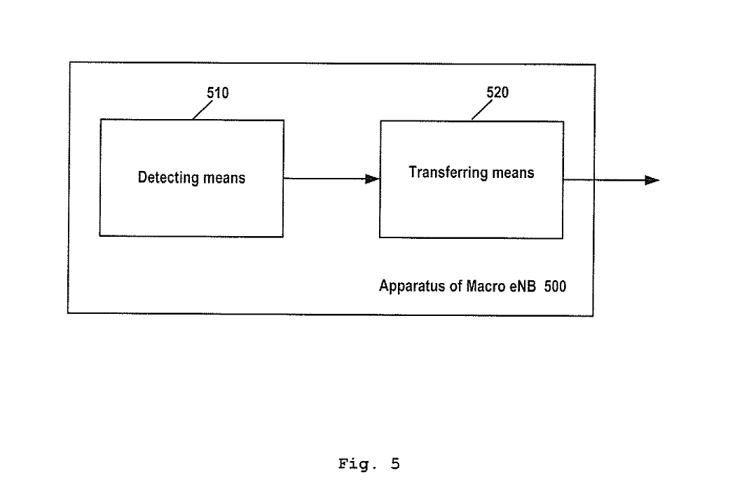

FIG. 5 schematically shows an exemplary apparatus of a macro eNB according to an embodiment of the present invention.

As shown in FIG. 5, reference numeral 500 denotes an apparatus of a macro eNB, which is working in the inter-site CA in a heterogeneous network and acting as a master node in the inter-site CA.

According to an embodiment of the present invention, the apparatus of the macro eNB 500 comprises a detecting means 510 for performing detection for whether there is a trigger for transferring UE context. The UE context is indispensable for a successful re-establishment and may include, but not limited to: AS-Config, AS-context, and security context like ShortMAC-I, KeNB*, etc etc.

For example, the triggers for transferring the UE context may comprise:

Trigger a): UE context transferring is triggered whenever UE enters into inter-site CA mode. That is, whenever a slave node is newly configured to a UE, the master node transfers the UE context to the slave node. This kind of trigger can be applied alone or applied in combination with other trigger(s). When applied alone, the trigger is favorable to the situation where UE context rarely changes in the master node side.

Trigger b): UE context transferring is trigged whenever UE context is changed in the master node. The master node can transfer the UE context to the slave node(s) once the UE context has changed so that the slave node(s) always has the most up-to-date UE context. This kind of trigger can be applied in combination with Trigger a) so as to update the UE context in the slave node(s) when the UE context changes in the master node.

Trigger c): UE context transferring is triggered by the handover failure detection at the master node side, e.g. when the master node does not receive handover complete message. This trigger is suitable for the situation where the re-establishment is triggered by handover failure. When UE initiates re-establishment caused by handover failure to the slave node, the master node might have transferred the UE context through backhaul to the slave node to make it prepared for the re-establishment. This kind of trigger can be applied in combination with Trigger a) or Triggers a) and b).

Once a trigger is detected by detecting means 510, a transferring means 520 transfers up-to-date UE context to a slave node(s).

In an embodiment of the present invention, transferring means 520 can transfer UE context via X2 interface, by which eNBs are interconnected with each other, to the slave node (s). In another embodiment of the present invention, transferring means 520 can transfer UE context via S1 interface by which eNBs are interconnected with the core networks, to the core networks. Through the core networks, the UE context is then transferred to the slave node(s).

According to the embodiments of the present invention, the advantage is that a slave node can always obtain the UE context from the master node and thus is prepared for potential re-establishment. Once UE selects this slave node to attempt re-establishment, the re-establishment success will be guaranteed so that user experience is improved.

A method for enabling Re-establishment performed in a master node such as a macro eNB according to an embodiment of the present invention has been depicted in detail with reference to FIG. 4. It should be noted that the above depiction is only exemplary, not intended for limiting the present invention. In other embodiments of the present invention, this method may have more, or less, or different steps, and numbering the steps is only for making the depiction more concise and much clearer, but not for stringently limiting the sequence between each steps, while the sequence of steps may be different from the depiction. For example, in some embodiments, the above one or more optional steps may be omitted. Specific embodiment of each step may be different from the depiction. All these variations fall within the spirit and scope of the present invention.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block and signaling diagrams, it is well understood that these blocks, apparatus, systems, techniques or methods described herein maybe implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. As well known in the art, the design of integrated circuits is by and large a highly automated process.

The present invention may also be embodied in the computer program product which comprises all features capable of implementing the method as depicted herein and may implement the method when loaded to the computer system.

The present invention has been specifically illustrated and explained with reference to the preferred embodiments. The skilled in the art should understand various changes thereto in form and details may be made without departing from the spirit and scope of the present invention.

1-15. (canceled)

16. A method, comprising:
performing detection for whether there is a trigger for transferring UE context which is indispensable for a successful re-establishment procedure for a user equipment to at least one slave node;
transferring, once said trigger is detected, said UE context to said at least one slave node.

17. A method according to claim 16, wherein transferring said UE context is trigged whenever said user equipment enters into inter-site carrier aggregation mode.

18. A method according to claim 16, wherein transferring said UE context is trigged whenever said UE context is changed at said master node.

19. A method according to claim 16, wherein transferring said UE context is trigged whenever handover failure is detected at said master node.

20. A method according to claim 16, wherein said UE context is transferred via X2 interface.

21. A method according to claim 16, wherein said UE context is transferred via S1 interface through core networks.

22. A method according to claim 16, wherein said UE context comprises AS-Config, AS-context, and security context ShortMAC-I, KeNB*.

23. An apparatus, comprising:
at least one processor; and
at least one memory including computer program code,
wherein the at least one memory and the computer program code are configured to, with the at least one processor, cause the apparatus to perform at least the following:
detect a trigger for transferring UE context which is indispensable for a successful re-establishment procedure for a user equipment to at least one slave node;
transfer, once said trigger is detected, said UE context to said at least one slave node.

24. An apparatus according to claim 23, wherein transferring said UE context is trigged whenever said user equipment enters into inter-site carrier aggregation mode.

25. An apparatus according to claim 23, wherein transferring said UE context is trigged whenever said UE context is changed at said master node.

26. An apparatus according to claim 23, wherein transferring said UE context is trigged whenever handover failure is detected at said master node.

27. An apparatus according to claim 23, wherein said UE context is transferred via X2 interface.

28. An apparatus according to claim 23, wherein said UE context is transferred via S1 interface through core networks.

29. An apparatus according to claim 23, wherein said UE context comprises AS-Config, AS-context, and security context ShortMAC-I, KeNB*.

30. A non-transitory computer-readable medium encoded with instructions that, when executed by at least one processor, perform at least the following:
performing detection for whether there is a trigger for transferring UE context which is indispensable for a successful re-establishment procedure for a user equipment to at least one slave node;
transferring, once said trigger is detected, said UE context to said at least one slave node.
